(19) United States
(12) Patent Application Publication
(10) Pub. No.: US 2015/0368892 A1
(43) Pub. Date: Dec. 24, 2015

(54) Underground Silo System for Storing Liquids

(71) Applicant: Safieh Gorjan, Torrance, CA (US)

(72) Inventor: Safieh Gorjan, Torrance, CA (US)

(21) Appl. No.: 14/310,158

(22) Filed: Jun. 20, 2014

(51) Int. Cl. E03F 1/00; E03F 3/04; E21F 16/00; E03F 5/10; B65G 5/00; E21F 17/16

(52) U.S. Cl. CPC E03F 1/003; B65G 5/00; E21F 17/16; E21F 16/00; E03F 5/10; E03F 3/04

(57) ABSTRACT

A method for storing liquids underground using a system of spatially distributed and interconnected silos

### FIELD OF THE INVENTION

The present invention is in the field of devices for storing liquids. More specifically, the present invention relates to the storage of stormwater runoff in urban areas in a spatially distributed manner.

### BACKGROUND OF THE INVENTION

Storage of stormwater runoff from urban areas, which normally flows in storm drains to water bodies such as rivers and beaches, is becoming an imperative driven by water scarcity and regulations to prevent and mitigate pollution. The volume of the stormwater runoff that needs storage is often very large such that finding suitable sites to place the storage facilities is difficult because of the scarcity of large plots of land in urban areas.

Stormwater runoff is generated when precipitation from rain and snowmelt flows over land or impervious surfaces such as paved streets, parking lots, and building rooftops, and does not percolate into the ground. Urbanization has resulted in an increase in the volume and rate of stormwater runoff and has elevated the concentration of pollutants. As the runoff flows over the land or impervious surfaces, it accumulates debris, chemicals, sediment or other pollutants that could adversely affect water quality if the runoff is discharged untreated.

The Environmental Protection Agency (EPA) is the regulatory agency for stormwater. The EPA considers most stormwater discharges as point sources, which require coverage under National Pollution Discharge Elimination System (NPDES) permit. The permit sets specific criteria for the volume, rate, and quality of stormwater runoff discharges, which discharges must comply with or face fines.

The primary means of controlling the polluted stormwater discharges to comply with EPA NPDES permit requirements is the use of Best Management Practices (IBMPs). These are approaches, tools, technologies, methods, and practices devised to counter the effect of urbanization by reducing the volume and rate of stormwater runoff and removing pollutants. The flow through treatment capacity of most BMPs is generally much less than the storm drain wet-weather flow rate at a given location. Therefore, most BMPs require an adequate-size facility to store the water for later release and treatment by the BMP. Without storage, only a small fraction of the stormwater, which is only available during the storm event, may be diverted to the BMP for treatment thus making them ineffective.

The size of the storage facility needed depends on the volume of water to be diverted and treated to comply with the NPDES permit for a given urban watershed. It can be as little as a few thousand gallons, but is typically in the order of several million gallons. Usually, the storage facility must be located near the point of diversion and adjacent to the BMP to minimize the need for conveyance and the associated costs. Often, this requires a large plot of unoccupied and suitably located land to house the storage facility, which is hard to find in most urban areas. Indeed, the availability of suitable land to accommodate adequate storage has become a major impediment to implementing urgently needed stormwater runoff BMPs in many urban areas.

Therefore, there is a need for a simple and practical method of storing stormwater runoff that does not require large plots of land. Such a system would remove a major impediment to implementing urgently needed stormwater runoff BMPs. It can also be used for applications other than for storing stormwater wherever it proves to be a feasible and the preferred method of storing liquids.

### SUMMARY OF THE INVENTION

The present invention eliminates the need for large plots of land for storing urban stormwater runoff by using a plurality of underground silos, longitudinally disposed at intervals alongside the storm drain in the public right of way (roadway, sidewalk, easements), and incrementally connected to the storm drain to receive and store the stormwater runoff from the storm drain. Each silo is a vertical hole in the ground having a certain diameter and depth, and is lined with a suitable liner that provides it with long-term structural integrity and water impermeability. Each silo is sized and designed to store a portion of the total storage volume required, with the sum of storage capacities of all silos equaling or exceeding the required total storage volume.

The silos are entirely below ground and flush with the ground surface at the top, in a manner similar to current service manholes for various urban utilities such as sewer, water, and electricity. They may be interconnected connected with underground conduits to permit water flow from one silo to the next by gravity, and enable access to the storage of the interconnected silos from a single low point. The interconnection between the silos may be equipped with valves that are normally open and automatically close at a pre-set water elevation. At least one of the silos is receives the water diverted from the storm drain via an appropriately sized and disposed conduit. In addition to delivering the diverted water, the conduit may serve to provide overflow protection by conveying excess water from the silo to the storm drain.

Diversion of water from the storm drain may be accomplished in a number of ways as is currently practiced. It may be accomplished by tapping into the storm drain at a certain elevation, or may need a special-purpose diversion structure. The diversion would be configured to divert water automatically from the storm drain at a certain desired water depth corresponding to a certain storm drain flow. The diverted water may connect to a pretreatment unit to screen out debris and settle out the solids before conveyance to the silos. Such pretreatment technology for diverted stormwater is widely available.

Construction of the silos may be accomplished by vertical augur drilling followed by structural lining of the augured hole. Augur drilling is a widely available technology used for constructing bridge piers. It is capable of drilling holes in the ground with diameters of up to 14 feet and depths of 200 feet or more in a wide range of ground conditions. Structural lining can be accomplished by using steel or Corrugated Metal Pipe (CMP) inserts following by grouting, in-situ concrete lining, or using a variety of available segmental liners. The bottom of the silos must be sealed, which may be done using an appropriate concrete mix. The finished silos are impermeable permanent vertical holes in the ground for water storage that fully isolate the diverted water from the surrounding ground and environment.

Construction of interconnecting conduits between the silos and the diversion conduit from the storm drain or the pretreatment unit may be accomplished by readily available horizontal boring machines that have been developed for trenchless installation of sewer, water, and gas pipes. The size and details of these conduits are case-specific to be determined during the design process.

The diameter, depth, and number of silos required depends on the total volume of water that is to be stored. As an example, a single 10-feet diameter vertical shaft drilled down to a depth of 55 feet below ground, having its maximum storage water level at 10 feet below ground such that 45 feet of the drilled shaft is available for storage provides a nominal available storage space of 25,000 gallons. Assuming identical vertical shafts and a total water storage requirement of 1.0 million gallons, one would require 40 such shafts to accommodate the total storage required. The shafts may be constructed at close intervals in the public right of way adjacent to the storm drain, and would be sited to clear any existing underground utilities. Assuming an average vertical shafts interval of 50 feet, a total distance of 2000 linear feet along the storm drain would be required to construct all 40 shafts. The actual diameters, depths, and intervals of the silo shafts is established and finalized during design. It will be determined on a case-by-case basis based on considerations that include; total storage volume required, optimum size and number of the silos, urban setting and site constraints, geology, depth to ground water, the need to minimize disruption to the public and traffic during construction, and locally available technology.

The valves fitted to interconnecting conduits are similar in operation to float valves most commonly used in toilet flush tanks, in that they are actuated by the rising water level and achieve complete closure at a pre-set level. There are a number of mechanisms and available technologies that can be used for the valve of this invention, including mechanism used in float valves. One option is to use hydraulically actuated pinch valves, with the hydraulic actuator activated by the pressure of the rising water level in the silo.

Once constructed, the underground silo water storage system is self-operating. Stormwater runoff flowing in the storm drain starts diverting into the silos via the diversion conduits once the water level in the storm drain at each diversion point reaches a certain elevation. Water diverted into each silo drops vertically down and then flows downstream through the interconnected silos by gravity, so long as the valves remain open. With interconnected silos, diverted water flows toward the silo at the most downstream end, which is the first to fill and close its valve thus preventing additional water entering it from silos upstream. Additional filling may occur directly from the storm drain for that silo, but it comes to a halt once the water level in the silo approaches the water level in the storm drain. Any overfilling due to valve malfunction is mitigated by the reversal of the flow in the diversion pipe towards the storm drain. The silo filling process in interconnected silos thus propagates from the downstream up with the sequential closure of the interconnection valves. The water level in the silos can only go up as high as the water level in the storm drain and recedes down to just below the diversion pipe invert once the storm event is over.

System emptying can occur either by employing submersible pumps at one or more silos, or can be by gravity by equipping one or more siloes with free outlets (if possible). The stored water can be emptied back into the storm drain during dry-weather conditions for subsequent downstream diversion and treatment, or it can be directly conveyed to one or more BMP treatment and/or water reuse facilities.

It is an object of this invention to provide a simple and constructible system of storing water, particularly diverted stormwater runoff that does not require large plots of dedicated land, and which can be accommodated and implemented in congested urban areas within existing public right of way.

It is an object of this invention to provide improved elements and arrangements by apparatus for the purposes described thereof, which is comparable in cost with existing systems, dependable, and fully effective in accomplishing its intended purposes.

These and other objects of the present invention will become readily apparent upon further review of the following specification and drawings.

### BRIEF DESCRIPTION OF THE DRAWINGS

FIG. 1 is a profile of the preferred embodiment of the present invention during dry-weather flow conditions with water level in the storm drain below the diversion level and the silos void of water.

FIG. 2 is an end view of the preferred embodiment of the present invention during dry-weather flow conditions corresponding to Section 2 of FIG. 1.

FIG. 3 is a profile of the preferred embodiment of the present invention during wet-weather flow conditions with water level in the storm drain above the diversion level and the downstream silos having filled while the upstream silos are filling.

FIG. 4 is an end view of the preferred embodiment of the present during wet-weather flow conditions corresponding to Section 4 in FIG. 3 showing a silo as it is filling.

FIG. 5 is an end view of the preferred embodiment of the present invention during wet-weather flow conditions corresponding to Section 5 in FIG. 3 showing a silo that has surpassed its full capacity with its water level at approximately the same level as the water level in the storm drain.

FIG. 6 is a profile of the preferred embodiment of the present invention after the passing of the wet-weather flow conditions with water level in the storm drain fallen down to below the invert of the upper connecting pipe.

FIG. 7 is an end view of the preferred embodiment of the present invention after a wet-weather flow event corresponding to Section 7 in FIG. 6 showing a silo having received water that is less than its full-storage level.

FIG. 8 is an end view of the preferred embodiment of the present invention after a wet-weather flow event corresponding to Section 8 in FIG. 6 showing a silo having filled to its full-storage level.

### DETAILED DESCRIPTION

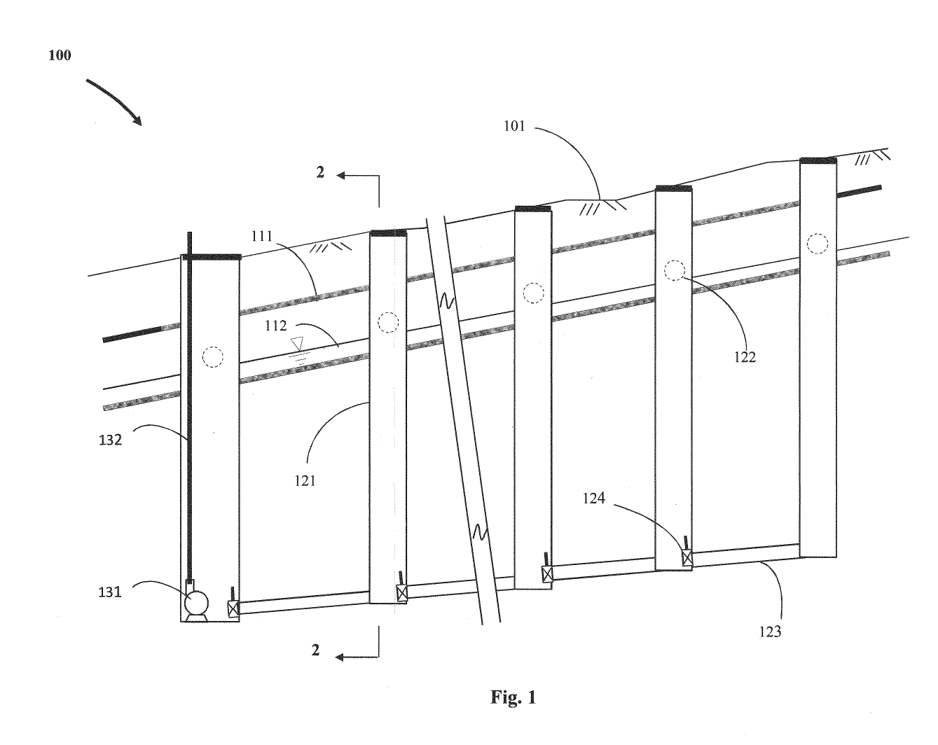

Referring to FIG. 1, there is shown the profile of the preferred embodiment of the invention 100 comprised of storm drain 111 running below ground 101, which may normally have dry-weather water 112 flowing inside. Diversion conduits 122 connect the storm drain 111 to a plurality of underground silos 121 via a plurality of pretreatment units 126 and to one another via lower connecting conduits 123. The lower connecting conduits 123 are equipped with valves 124 that may be located inside the silo immediately downstream. The valves 124 operate based on the water level of the silo 121 into which they discharge. They are normally open when the water level is below the full-capacity condition of the silo 121, and fully close once the silo 121 is full. The last silo 121 downstream may be equipped with a submersible pump 131 connected to pipe 132 to discharge the stored water. Alternatively, the pump 131 and discharge pipe 132 may be replaced by a gravity flow outlet (not shown) if the local terrain permits.

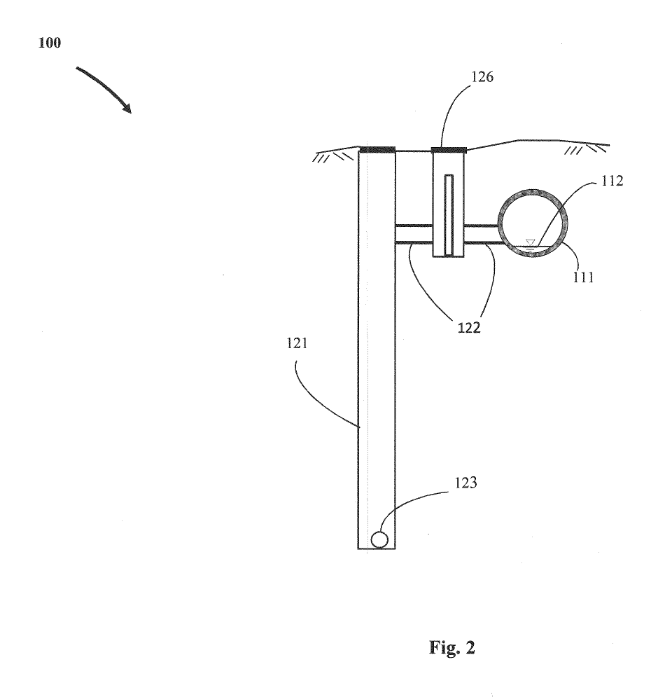

FIG. 2 is an end view of the preferred embodiment of the present invention 100 during dry-weather flow conditions corresponding to Section 2 of FIG. 1. The elevation of the diversion conduit 122 that connects the storm drain 111 to the underground silo 121 via pretreatment unit 126 is set at a level above the dry-weather flow water level 112 in the storm drain to avoid diverting the dry-weather flow into the underground silo 121 storage system. Alternatively, the elevation of the diversion conduit 122 could be set lower to divert the dry-weather flow if that is desired. The underground silo 121 is void of any water and there is no water flowing in the interconnection conduits 123.

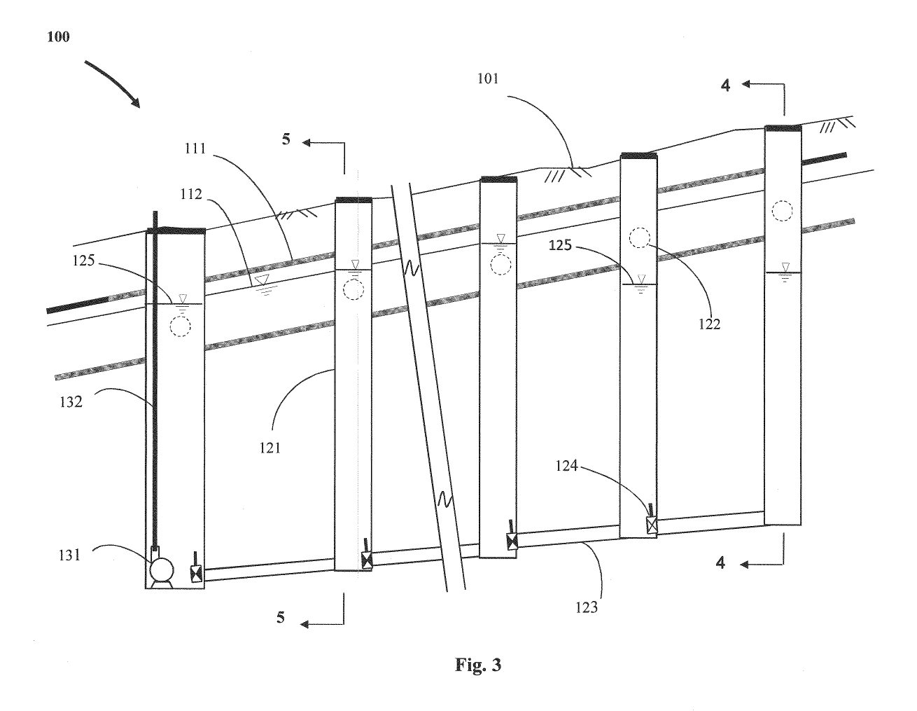

FIG. 3 is the profile of the preferred embodiment of the present invention 100 during wet-weather flow conditions with water level 112 in the storm drain 111 above the invert of the diversion conduit 122. Stormwater runoff 112 in storm drain 111 is diverted through to silos 121 via pretreatment units 126 and conveyed downstream through the silos via interconnection conduits 123. As the diverted water accumulates, valves 124 in silos 121 where the water level 125 reaches a certain a pre-set elevation close, thus preventing additional water from the upstream silos entering it. This normally occurs in the downstream silos first, and propagates upstream. A logical pre-set elevation for valve 124 to close is a small vertical distance below the invert elevation of the diversion conduit 122. This is because water level 125 in the silo 121 going above the invert elevation of the diversion conduit 122 would flow back into the storm drain 111 once the water level 112 in the storm drain 111 recedes. Valves 124 in FIG. 3 that are closed because the water level 125 in their silos 121 has reached the pre-set level are depicted by solid triangles, while hollow triangles depict open valves 124 for which the water level 125 in their silos 121 has not reached the pre-set level.

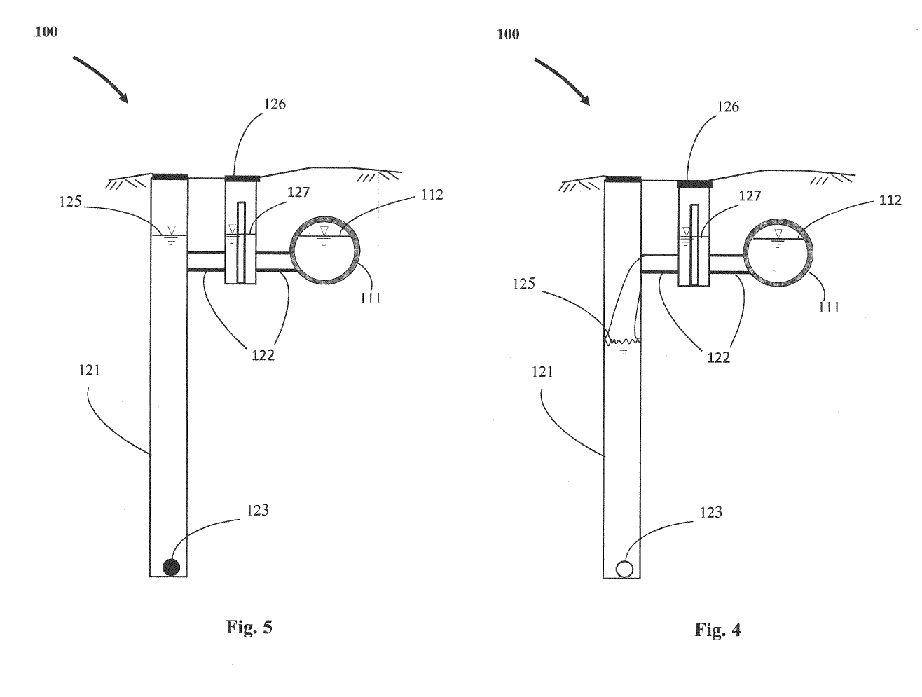

FIG. 4 is an end view of the preferred embodiment of the present invention 100 during wet-weather flow conditions corresponding to Section 4 in FIG. 3 showing an underground silo 121 as it is filling. Water level 112 in the storm drain 111 is above the invert of the diversion conduit 122. Stormwater runoff 112 in storm drain 111 is diverted to silos 121 via pretreatment units 126 and conveyed downstream through the silos via interconnection conduits 123. The water level 125 in the silo 121 is below the pre-set level and water flows from the storm drain 111 into the silo 121. The cross section of the interconnection conduit 123 is depicted with a hollow circle to show that valve 124 is open. This is because the water level 125 in the silo 121 immediately downstream is also below the full-level condition.

FIG. 5 is an end view of the preferred embodiment of the present invention during wet-weather flow conditions corresponding to Section 5 in FIG. 3. It shows a silo 121 that has surpassed its full capacity with its water level 125 above the invert elevation of the diversion conduit 122 at approximately the same level as the water level 127 in the pretreatment unit 126, and the water level 112 in the storm drain 111. Therefore, the valve 124 on the interconnection conduit 123 from the silo 121 upstream is closed to stop any additional filling of this silo from upstream. Any inflow/outflow to/from a silo 121 with its valve 124 closed occurs entirely because of the difference between water level 125 in the silo 121 and water level 112 in the storm drain 111. During rising stormwater level 112 in storm drain 111, water flows from the storm drain 111 into the silo 121, and vice versa. The cross section of the interconnection conduit 123 is depicted with a solid circle to show that its valve 124 is closed. This is because the water level 125 in the silo 121 immediately downstream is also above the full-level condition

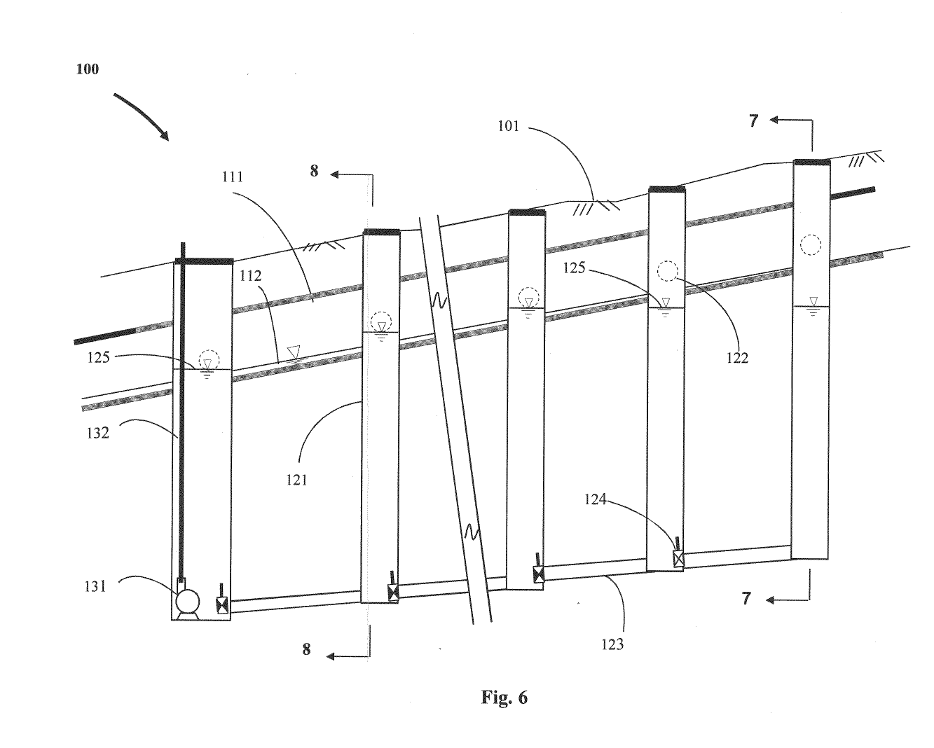

FIG. 6 is a profile of the preferred embodiment of the present invention after the passing of the storm event with water level 112 in the storm drain 111 having fallen down to below the diversion conduit 122. Those silos 121 in the system that have received water equal or in excess of their storage capacity are full with their water level 125 at approximately the same elevation as the inlet of their respective diversion conduits 122, and their valves 124 closed. Those silos 121 that have received less water than their storage capacity are less than full have their altitude valves 124 open. This represents the final water storage condition corresponding to a particular storm water event.

FIG. 7 is an end view of the preferred embodiment of the present invention after a wet-weather flow event corresponding to Section 7 in FIG. 6 showing a silo 121 having received water that is less that its full-storage level. Water level 112 in the storm drain 111 has fallen below the invert elevation of the diversion conduit 122 ceasing any water diversion. Water level 125 in the silo 121 and water level 127 in the pretreatment unit 126 are below the invert of the diversion conduit 122. The cross section of the interconnection conduit 123 is depicted with a hollow circle to show that it is open. This is because the water level 125 in the silo 121 immediately downstream is also below the full-level condition, which leaves the valve 124 open.

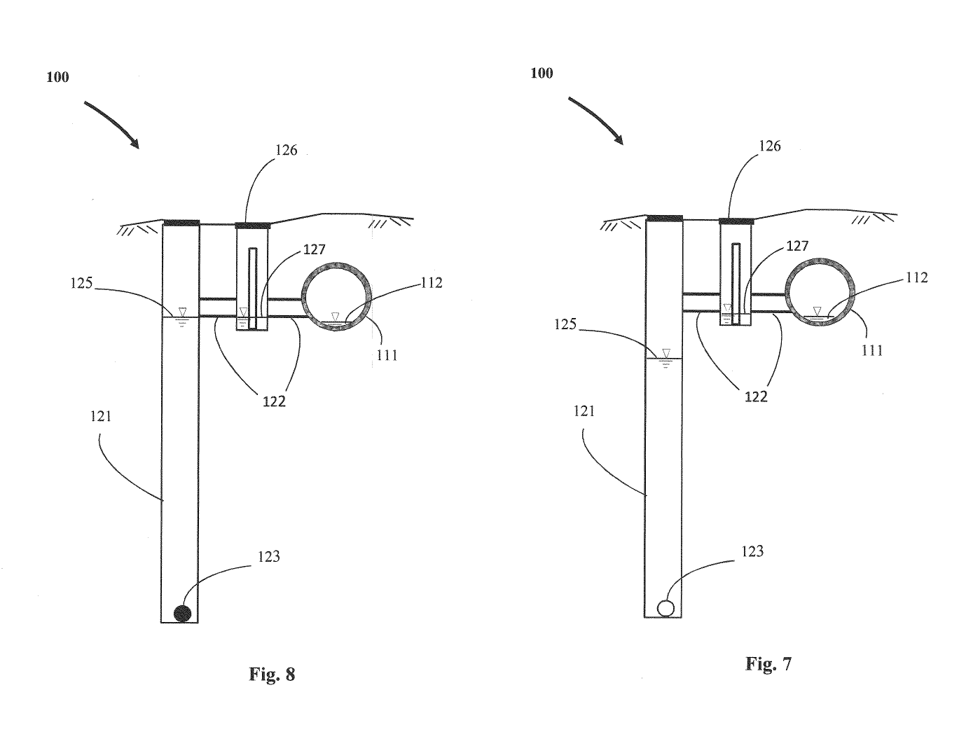

FIG. 8 is an end view of the preferred embodiment of the present invention after a wet-weather flow event corresponding to Section 8 in FIG. 6 showing a silo 121 having filled to its full-storage level. Water level 112 in the storm drain 111 has fallen to below the invert of the diversion conduit 122 ceasing any water diversion. Water level 125 in the silo 121 is near the same level as the invert of the diversion conduit 122. This means that either this silo 121 received the exact volume of water to fill it, or the water level 125 went above the invert elevation of diversion conduit 122 during the storm event and fell back down once the water level 112 in the storm drain 111 receded. Water level 127 in the pretreatment unit 126 is just below the invert of the diversion conduit 122. The cross section of the lower connecting conduit 123 is depicted with solid circle to show that the interconnection conduit 123 to the next silo 121 downstream is closed. This is because the water level 125 in the silo 121 immediately downstream is also at the full-level condition, which means that its valve 124 is closed.

The present invention is susceptible to modifications and variations which may be introduced thereto without departing from the inventive concepts and the object of the invention. Other applications that the present invention may be used for include but are not limited to storing; wastewater diverted from sanitary or combined sewers, potable water diverted from water conveyance canals and pipelines, and oil and hydrocarbon based liquids diverted from transmission pipelines. Furthermore, mechanisms other than those described may be employed to accomplish the main object of the present invention, which is to provide spatially distributed storage alongside conveyance conduits and pipelines.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1. A system for storing liquids underground in a spatially distributed manner, the system comprising:
at least one conveyance conduit that conveys a liquid;
at least one diversion conduit disposed to divert liquid from the said conveyance conduit;
a plurality of underground vertical hollow shafts disposed to receive and store the liquid diverted from the said conveyance conduit; and
a means of extracting the liquid from the said vertical hollow shafts, the means comprising:
a pump capable of operating at a desired extraction rate; and
a discharge pipe connected to the said pump.

2. The system of claim 1, wherein the liquid diverted from the said conveyance conduit passes through at least one pretreatment facility disposed to receive and pretreat the diverted liquid prior to conveyance to the said vertical hollow shafts.

3. The system of claim 1, wherein the plurality of the said vertical hollow shafts are interconnected by means of underground conduits disposed to convey the liquid through the said vertical hollow shafts by gravity.

4. The system of claim 3, wherein the said underground conduits are fitted with valves disposed to open and close.

5. The system of claim 1, wherein the means of extracting the liquid is by gravity.
